(19) United States
(12) Patent Application Publication
(10) Pub. No.: US 2021/0179299 A1
(43) Pub. Date: Jun. 17, 2021

(54) HIGH TEMPERATURE LAYERED TILE INSULATION SYSTEM FOR AEROSPACE VEHICLES

(71) Applicant: SIERRA NEVADA CORPORATION, Sparks, NV (US)

(72) Inventors: Michael Hoening, Boulder, CO (US); Michelle Hoffmann, Lafayette, CO (US); Kevin Moynihan, Louisville, CO (US); Robert Slingsby, Lyons, CO (US)

(21) Appl. No.: 16/716,387

(22) Filed: Dec. 16, 2019

(51) Int. Cl. B64G 1/58; B64G 1/22; B32B 18/00; B32B 9/00

(52) U.S. Cl. CPC B64G 1/58; B64G 1/226; B64G 1/14; B32B 9/007; B32B 18/00

(57) ABSTRACT

Various systems and methods of a layered tile insulation system of a space vehicle, configured to withstand vibration, high temperatures, and extreme thermal gradients, are disclosed. The layered tile insulation system can include at least one layered tile, each of the at least one layered tile including an outer layer having a first interlocking surface with a first set of interlocking features and an inner layer having a second interlocking surface with a second set of interlocking features, such that the outer layer is configured to be couple to the inner layer thereby forming a mechanical joint via the interlocking of the first interlocking surface with the second interlocking surface.

### TECHNICAL FIELD

The subject matter described herein relates to systems and methods associated with a layered tile insulation system.

### BACKGROUND

Space vehicles, also called aerospace vehicles, spaceplanes, or space shuttles, can be used to deliver cargo and/or people to areas outside the Earth's atmosphere, such as the International Space Station. During the initial ascent past the Earth's atmosphere, the space vehicle can be subjected to large mechanical stresses, including those generated by high frequency vibrations. The flight trajectory required to reach and return from orbit can result in significant aerodynamic loads, vibrations, and accelerations, which must be withstood by the space vehicle in order to safely survive re-entry and be functional for future use. Furthermore, space vehicles reentering the Earth's atmosphere must significantly reduce their travel velocity, which can result in extreme heating of the space vehicle. For example, during reentry, the space vehicle can be subjected to temperatures in excess of 3000 degrees Fahrenheit. The heating environment can also produce extreme thermal gradients along the space vehicle (e.g., outer surface of space vehicle to inner framework of space vehicle), such as a range of approximately below −130 degrees Fahrenheit to over approximately 3000 degrees Fahrenheit.

As such, the operation of such space vehicles can require exterior thermal insulation to protect the space vehicle against such extreme temperatures and temperature gradients. In addition to thermal stress, such insulation must also be able to withstand mechanical stresses associated with launch vibrations, acoustics, and any changes (e.g., movement) associated with the space vehicle's exterior surface, as well as forces experienced by the space vehicle as the space vehicle enters the atmosphere and lands. Previous layered insulating structures intended for use in such vehicles were more susceptible to failure due to thermal and mechanical loads, and have included multiple joining mechanisms, thereby adding weight and manufacturing complexity, as well as being difficult to inspect, replace, and/or reuse.

### SUMMARY

Aspects of the current subject matter can include various embodiments of a layered tile insulation system for aerospace vehicles, as well as methods of use and manufacturing of the layered tile insulation systems.

In an aspect, a layered tile insulation system of a space vehicle is described. The layered tile insulation system can include at least one layered tile. Each of the layered tiles of the at least one layered tile can include an outer layer having an outer surface and a first interlocking surface opposed to the outer surface. The first interlocking surface can include a first set of interlocking features. Additionally, each of the layered tiles can include an inner layer having an inner surface and a second interlocking surface opposed to the inner surface. The second interlocking surface can include a second set of interlocking features. The outer layer can be configured to be coupled to the inner layer thereby forming a mechanical joint. The mechanical joint can include the first set of interlocking features interlocked with the second set of interlocking features.

In some embodiments, the layered tile insulation system can include an adhesive within the mechanical joint, thereby forming a bond between the outer layer and the inner layer for assisting with securing a position of the outer layer relative to the inner layer. In some embodiments, the first set of interlocking features and the second set of interlocking features can have a complementary dovetail geometry. In some embodiments, a clearance of up to approximately 0.010″ may be formed within the mechanical joint and between the first set of interlocking features of the outer layer and the second set of interlocking features of the inner layer. In some embodiments, other clearances and/or fits can be included in the mechanical joint without departing from the scope of this disclosure, such as transition fits and/or interference fits as understood in the art.

In some embodiments, the outer layer can include an oxidation resistant carbon composite material. In some embodiments, the outer layer can include a material that resists oxidation at temperatures of at least approximately 3000 degrees Fahrenheit. In some embodiments, the outer layer can include one or more layers of Toughened Uni-piece Fibrous Insulation (TUFI) and a High Efficiency Tantalum-based Ceramic (HETC). In some embodiments, the inner layer can include TUFI and/or HETC. In some embodiments, the layered tile insulation system can be positioned along at least a part of a nose area, a wing leading edge area, and/or a flight control surface of the space vehicle. In some embodiments, the layered tile can have a shape including a first dimension of at least approximately 10 inches and a second dimension of at least approximately 10 inches.

In another interrelated aspect, a method of manufacturing a layered tile insulation system for a space vehicle is described. The method can include interlocking an outer layer of a layered tile insulation system with an inner layer of the layered tile insulation system to form a mechanical joint. The outer layer can have a first set of interlocking features, and the inner layer can have a second set of interlocking features. The mechanical joint can include the first set of interlocking features interlocked with the second set of interlocking features.

In some embodiments, the interlocking of the outer layer with the inner layer can include aligning the first set of interlocking features with the second set of interlocking features, and advancing the outer layer and the inner layer toward each other in opposing directions. In some embodiments, the first set of interlocking features and the second set of interlocking features can have a complementary dovetail geometry. In some embodiments, the interlocking can include applying, before the advancing, an adhesive to at least one of the first set of interlocking features and the second set of interlocking features. In some embodiments, the adhesive can be configured to maintain the local bond when surface temperatures of the outer layer reach temperatures of at least 3000 degrees Fahrenheit.

In some embodiments, the outer layer can include an oxidation resistant carbon composite material. In some embodiments, the outer layer can include a material that resists oxidation at temperatures of at least 3000 degrees Fahrenheit. In some embodiments, the outer layer can include one or more coats of TUFI and HETC. In some embodiments, the mechanical joint can be maintained during exposure to vibroacoustic environments exceeding 60 GRMS. In some embodiments, a clearance of up to approximately 0.010″ may be formed within the mechanical joint and between the first set of interlocking features of the outer layer and the second set of interlocking features of the inner layer. In some embodiments, other clearances and/or fits can be included in the mechanical joint without departing from the scope of this disclosure, such as transition fits and/or interference fits as understood in the art.

In some embodiments, the layered tile insulation system can be positioned along at least a part of a nose, a wing leading edge area, and/or a flight control surface of the space vehicle. In some embodiments, the at least one layered tile of the layered tile insulation system can have a shape including a first dimension of at least approximately 10 inches and a second dimension of at least approximately 10 inches.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A is a perspective view of an embodiment of a space vehicle.

FIG. 1B is a rear perspective view of the space vehicle of FIG. 1A.

FIG. 2A is an exploded view of an embodiment of a part of a layered tile insulation system of the space vehicle of FIG. 1A showing an embodiment of a layered tile.

FIG. 2B is a cross-sectional view of the layered tile of FIG. 2A showing the mechanical joint.

FIG. 3 is a cross-sectional view of another embodiment of the layered tile including a gap in the mechanical joint.

When practical, similar reference numbers denote similar structures, features, or elements.

### DETAILED DESCRIPTION

The present disclosure describes various embodiments of a layered tile insulation system that is configured to withstand vibration, high temperatures, and extreme thermal gradients. For example, the layered tile insulation system can form or be a part of an external protection system of a space vehicle to assist with protecting the space vehicle from thermal environments that would otherwise compromise the structural integrity of the space vehicle. For example, the layered tile insulation system described herein may be configured to withstand mechanical stresses experienced by the space vehicle during its exit from and/or reentry into Earth's atmosphere.

In some embodiments, the layered tile insulation system may include at least one layered tile. For example, each layered tile may include an outer layer and an inner layer. In some embodiments, the outer layer may include an outer surface and an opposed first interlocking surface. The inner layer may include an inner surface and an opposed second interlocking surface. The first interlocking surface may include a first set of interlocking features including at least one interlocking feature, and the second interlocking surface may include a second set of interlocking features including at least one interlocking feature. In some embodiments, the first set of interlocking features and the second set of interlocking features have a complementary dovetail geometry. As such, the interlocking surface of the outer layer is configured to be coupled to the interlocking surface of the inner layer to form a mechanical joint.

In some embodiments, the mechanical joint is formed by the interlocking of the first interlocking surface with the second interlocking surface. In some embodiments, the mechanical joint has sufficient strength such that it is maintained during exposure to vibroacoustic environments, and thermal shock resulting from rapid temperature increases up to and in excess of approximately 3000 degrees Fahrenheit. In some embodiments, the mechanical joint maintains tensile strength of at least 10 psi after exposure to thermal, mechanical, and vibroacoustic loads, such as those experienced by a space vehicle during its exit from and/or reentry into Earth's atmosphere.

In some embodiments, the mechanical joint may also include a ceramic adhesive. For example, the ceramic adhesive may be positioned between the outer layer and the inner layer of the layered tile, such as on the interlocking surfaces. The ceramic adhesive can provide additional stability to the mechanical joint by forming a local bond. For example, the ceramic adhesive may be capable of maintaining the local bond when surface temperatures of the outer layer reach temperatures of at least approximately 3000 degrees Fahrenheit without melting or disturbing the local bond.

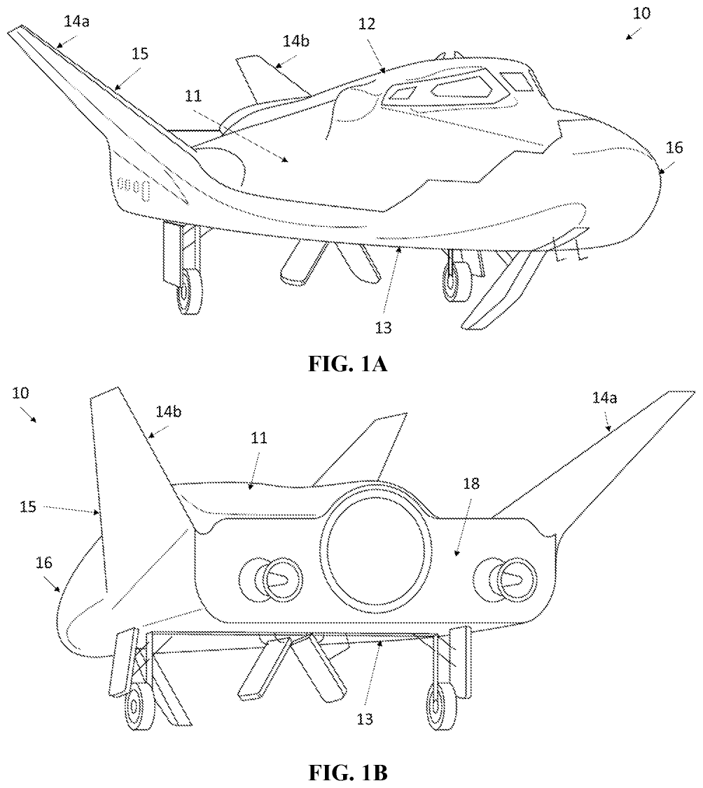

FIGS. 1A-1B illustrate an embodiment of a space vehicle 10 consistent with implementations of the present subject matter. As shown in FIGS. 1A-1B, the space vehicle 10 can include a body 12, with wings 14a and 14b extending from opposing sides of the body 12. The space vehicle 10 can also include a nose area 16 along a first end of the body 12, and a tail area 18 along a second, opposing end of the body 12. The body 12 can include a top side 11 that opposes an underside 13 that can include a wing leading edge area 15 and a part of the tail area 18. For example, the nose area 16, the wing leading edge area 15, the tail area 18, and the flight control surfaces (e.g., ailerons, rudders, thrusters, and/or spinning wheels) of the space vehicle 10 can experience a greatest amount of thermal stress during exit from and reentry into the atmosphere.

The layered tile insulation system described herein can provide protection against thermal environments that would otherwise compromise the structural integrity of the space vehicle 10, at least when included along a part of an external protection system of a space vehicle 10. For example, the external protection system can extend along any part of the body 12, such as the nose area 16, the wing leading edge area 15 and/or the tail area 18. The structural integrity of the layered tile insulation system can allow it to be used on flight control surfaces of any of a variety of space vehicles. Various embodiments of the layered tile insulation system are provided in greater detail below.

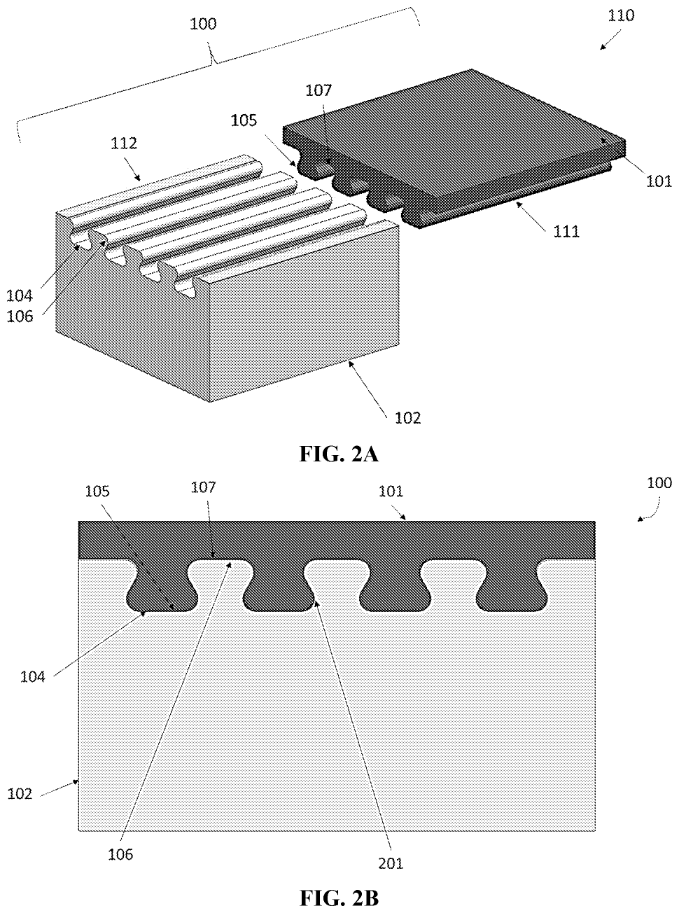

FIGS. 2A-2B illustrate an embodiment of a part of a layered tile insulation system 110 showing a layered tile 100 comprising an outer layer 101 and an inner layer 102. For example, the outer layer 101 can include a first interlocking surface 111 having at least one interlocking feature, including at least one dovetail protrusion 105, and at least one dovetail depression 107. For example, at least one dovetail depression 104 may be positioned adjacent to each of the at least one dovetail protrusion 105, as shown in FIG. 2A. The inner layer 102 can include a second interlocking surface 112 having at least one complementary interlocking feature including at least one dovetail depression 104, and at least one dovetail protrusion 106. For example, at least one dovetail depression 104 may be positioned adjacent to each of the at least one dovetail protrusion 106, as shown in FIG. 2A.

For example, as shown in FIGS. 2A and 2B, the at least one dovetail depression 104 of the inner layer 102 may be configured to align and interlock with the at least one dovetail protrusion 105 of the outer layer 101 to form the layered tile 100. Furthermore, at least one dovetail depression 107 of the outer layer 101 may be configured to align and interlock with at least one dovetail protrusion 106 of the inner layer 102 to form the layered tile 100.

As shown in FIG. 2B, the layered tile 100 can include a mechanical joint 201 that is formed by aligning and interlocking the interlocking features of the outer layer 101 with the interlocking features of the inner layer 102. The mechanical joint 201 can be configured to withstand extreme thermal, vibrational, and structural loads, such as those experienced by the space vehicle 10 during exit from and reentry into the atmosphere. Distributing mechanical loads across the mechanical joint 201 can result in an interface that is significantly stronger than typical external protection systems. The mechanical joint can thus eliminate the need for secondary attachment mechanisms, such as a pin or tab.

In some embodiments, the layered tile 100 can have a flat configuration (e.g., extend along a single plane), as shown in FIG. 2A. In some embodiments, the layered tile 100 can be curved and extend along a radius. Additionally and/or alternatively to a dovetail geometry, the interlocking features may include other shapes and configurations.

In some embodiments, the outer layer 101 and inner layer 102 may be configured such that no space is formed between the interlocking features of the outer layer 101 and the inner layer 102 to form the mechanical joint 201, resulting in an interference fit (also referred to as a press fit or friction fit), as shown in FIG. 2B. For example, such interference fit may minimize relative motion between the outer layer 101 and the inner layer 102 and/or mitigate cyclic deflections in a vibroacoustic environment.

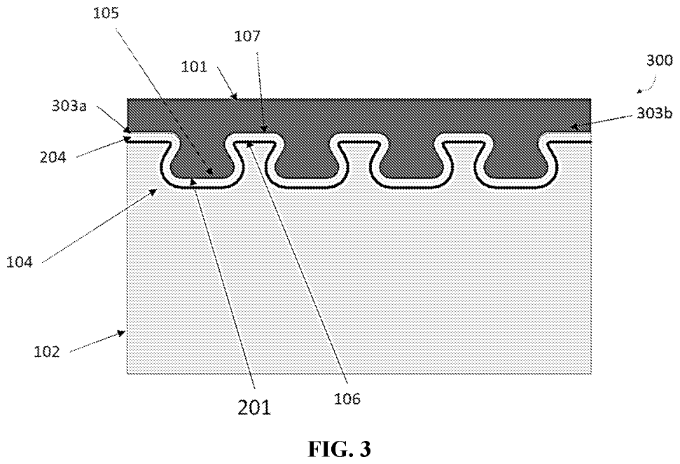

FIG. 3 illustrates another embodiment of a layered tile 300 including a mechanical joint 201 that includes a tolerance clearance or gap 204 between at least a part of the interlocking features of the outer layer 101 and the interlocking features of the inner layer 102. For example, the gap 204 can include a distance of approximately 0.010″ between the interlocked first interlocking features and second interlocking features. In some embodiments, the gap 204 can provide a space to include an adhesive for forming a local bond, though the gap 204 may or may not be filled with an adhesive. In embodiments where an adhesive is used, the gap 204 may be sized to allow a desired adhesive curing thickness to be achieved.

As shown in FIG. 3, the inner layer 102 may include at least one adhesive surface 303a and 303b, configured to apply an adhesive thereto for forming a local bond between the inner layer 102 and the outer layer 101. In some embodiments, the adhesive is a ceramic adhesive. For example, the adhesive may include Ceramabond™, such as Ceramabond™ 569 modified with silica, or other high temperature ceramic adhesive. Additionally and/or alternatively, the outer layer can include an adhesive surface without departing from the scope of this disclosure. Adhesive may be added along any part of the first interlocking surface 111 and/or the second interlocking surface 112 without departing from the scope of this disclosure.

In some embodiments, the outer layer 101 may include an oxidation resistant material. For example, the oxidation resistant material may include a porous oxidation resistant carbon matrix composite material such as Refractory Oxidation-resistant Ceramic Carbon Insulation (ROCCI). In some embodiments, the outer surface and/or sidewalls of the outer layer 101 may be further densified with High Efficiency Tantalum-based Ceramic (HETC) or Toughened Uni-piece Fibrous Insulation (TUFI), such as to increase oxidation resistance and impact resilience. Additionally and/or alternatively, the outer surface of the outer layer 101 may be coated in Reaction Cured Glass (RCG) or derivatives of RCG to improve stability, such as in atmosphere re-entry environments.

In some embodiments, the first interlocking surface of the outer layer 101 may be densified with HETC or Toughened Uni-piece Fibrous Insulation (TUFI), such as to increase mechanical strength, and/or to better match the coefficient of thermal expansion of the inner layer 102. In some embodiments, the inner layer 102 may include a porous insulating ceramic material. For example, Alumina Enhanced Thermal Barrier (AETB), Lockheed Insulation 22 pounds per cubic foot (LI-2200), Boeing Rigid Insulation 18 pounds per cubic foot (BRI-18), or similar may be used to form the inner layer 102. A primary function of the inner layer 102 may be insulation, however a material with a relatively high density (i.e. greater than 12 pounds per cubic foot) may be used to maximize the strength of the mechanical joint formed by the interlocking of the inner layer 102 to the outer layer 101. In some embodiments, the second interlocking surface of the inner layer 102 may be densified with HETC or TUFI, such as to increase mechanical strength and/or to better match the coefficient of thermal expansion of the outer layer 101. In some embodiments, the second interlocking surface may additionally and/or alternatively be densified with TUFI and/or HETC or similar to increase the strength of the contacting surfaces in the mechanical joint 201 (shown in FIG. 2B). In some embodiments, the inner surface of the inner layer 102 may be densified with similar suitable materials to increase thermal shock resistance and add strength.

In some embodiments, the layered tile 100 may have a regular shape, such as a rectangle or square shape. In other embodiments, the layered tile 100 may have an irregular shape and/or have non-orthogonal sidewalls. For example, the layered tile 100 can have a shape with a top profile having a first dimension (e.g., length), a second dimension (e.g., width), and a third dimension (e.g., thickness). For example, the first and second dimensions can both be approximately 10 inches. In some embodiments, the layered tile 100 has a length of 5 inches, a width of 5 inches, and a thickness of 5 inches. In some embodiments, the layered tile 100 has a length of 10 inches, a width of 10 inches, and a thickness of 7 inches. The layered tile 100 can have a variety of shapes and sizes without departing from the scope of this disclosure.

During assembly of the layered tile 100, the outer layer 101 of a layered tile 100 of the layered tile insulation system 110 can be interlocked with an inner layer 102 of the layered tile 100 of the layered tile insulation system 110, to form a mechanical joint 201. For example, the outer layer 101 can have a first set of interlocking features and the inner layer 102 can have a second set of interlocking features, with the mechanical joint 201 including the first set of interlocking features interlocked with the second set of interlocking features. In some embodiments, the interlocking of the outer layer 101 with the inner layer 102 can further include aligning the first set of interlocking features with the second set of interlocking features and advancing the outer layer 101 and the inner layer 102 toward each other in opposing directions. Other methods for assembling the layered tile 100 are within the scope of this disclosure. For example, adhesive can be applied to at least a part of the inner layer 102 and/or outer layer 101, such as prior to and/or during assembly of the layered tile 100, to form a local bond in the mechanical joint 201.

In some embodiments, once the layered tile 100 has been assembled, an outer mold line (OML) of the assembled layered tile 100 can be coated with one or more layers of HETC or TUFI and one or more layers of RCG or modified RCG. Such an assembled layered tile 100 can be exposed to temperatures exceeding approximately 3000 degrees Fahrenheit and 3-axis vibration environments exceeding 60 GRMS and retain a tensile strength in excess of 10 psi (as applied to the full OML surface area).

The layered tile insulation system 110 comprising a plurality of layered tiles 100 may enable verification of integrity via simple proof testing, such that the layered tiles 100 may be safely and reliably re-used on multiple flights of a space vehicle 10. For example, the layered tiles 100 may be inspected to ensure integrity of the mechanical joints 201 and/or adhesive bonds. Additionally, some embodiments of the layered tile insulation system 110 may reduce part count, processing time, and complexity relative to existing external protection systems for space vehicles.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

It should be appreciated that the layered tile insulation system 110 described herein may be used for any system or device that experiences high temperatures and/or mechanical stresses.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments

What is claimed is:

1. A layered tile insulation system of a space vehicle, comprising:
at least one layered tile, wherein each of the layered tiles of the at least one layered tile comprises
an outer layer having an outer surface and a first interlocking surface opposed to the outer surface, the first interlocking surface including a first set of interlocking features, and
an inner layer having an inner surface and a second interlocking surface opposed to the inner surface, the second interlocking surface including a second set of interlocking features,
wherein the outer layer is configured to be coupled to the inner layer thereby forming a mechanical joint, the mechanical joint including the first set of interlocking features interlocked with the second set of interlocking features.

2. The layered tile insulation system of claim 1, further comprising an adhesive within the mechanical joint and forming a bond between the outer layer and the inner layer for assisting with securing a position of the outer layer relative to the inner layer.

3. The layered tile insulation system of claim 1, wherein the first set of interlocking features and the second set of interlocking features have a complementary dovetail geometry.

4. The layered tile insulation system of claim 1, wherein the layered tile insulation system is positioned along high temperature regions including at least a part of a nose area, a leading edge area, and/or a flight control surface of the space vehicle.

5. The layered tile insulation system of claim 1, wherein the outer layer comprises an oxidation resistant carbon composite material.

6. The layered tile insulation system of claim 1, wherein the outer layer includes a material that resists oxidation at temperatures of at least 3000 degrees Fahrenheit.

7. The layered tile insulation system of claim 1, wherein the outer layer includes one or more layers of Toughened Uni-piece Fibrous Insulation (TUFI) and a High Efficiency Tantalum-based Ceramic (HETC).

8. The layered tile insulation system of claim 1, wherein the inner layer includes TUFI and/or HETC.

9. The layered tile insulation system of claim 1, wherein a clearance of up to approximately 0.010″ is formed within the mechanical joint and between the first set of interlocking features of the outer layer and the second set of interlocking features of the inner layer.

10. The layered tile insulation system of claim 1, wherein a transition fit is formed within the mechanical joint and between the first set of interlocking features of the outer layer and the second set of interlocking features of the inner layer.

11. The layered tile insulation system of claim 1, wherein an interference fit is formed within the mechanical joint and between the first set of interlocking features of the outer layer and the second set of interlocking features of the inner layer.

12. The layered tile insulation system of claim 1, wherein a layered tile of the at least one layered tile comprises a shape including a first dimension of at least approximately 10 inches and a second dimension of at least approximately 10 inches.

13. A method of manufacturing a layered tile insulation system for a space vehicle comprising at least one layered tile, the method comprising
interlocking an outer layer of the at least one layered tile with an inner layer of the at least one layered tile to form a mechanical joint, the outer layer having a first set of interlocking features and the inner layer having a second set of interlocking features, the mechanical joint including a first set of interlocking features interlocked with a second set of interlocking features.

14. The method of claim 13, wherein the interlocking of the outer layer with the inner layer comprises:
aligning the first set of interlocking features with the second set of interlocking features; and
advancing the outer layer and the inner layer toward each other in opposing directions.

15. The method of claim 14, wherein the first set of interlocking features and the second set of interlocking features have a complementary dovetail geometry.

16. The method of claim 14, wherein the interlocking further comprises:
applying, before the advancing, an adhesive to at least one of the first set of interlocking features and the second set of interlocking features.

17. The method of claim 13, wherein the layered tile insulation system is positioned along at least a part of a nose, a wing leading edge area, and/or a flight control surface of the space vehicle.

18. The method of claim 13, wherein an adhesive is configured to maintain a local bond within the mechanical joint when the surface temperature of the outer layer is at temperatures of at least 3000 degrees Fahrenheit.

19. The method of claim 13, wherein the mechanical joint is maintained during exposure to vibroacoustic environments exceeding 60 GRMS.

20. The method of claim 13, wherein the outer layer comprises an oxidation resistant carbon composite material.

21. The method of claim 13, wherein the outer layer comprises a material that resists oxidation at temperatures of at least 3000 degrees Fahrenheit.

22. The method of claim 13, wherein the outer layer comprises one or more layers of TUFI and HETC.

23. The method of claim 14, wherein a clearance of up to approximately 0.010″ is formed within the mechanical joint and between the first set of interlocking features of the outer layer and the second set of interlocking features of the inner layer.

24. The method of claim 14, wherein a transition fit is formed within the mechanical joint and between the first set of interlocking features of the outer layer and the second set of interlocking features of the inner layer.

25. The method of claim 14, wherein an interference fit is formed within the mechanical joint and between the first set of interlocking features of the outer layer and the second set of interlocking features of the inner layer.

26. The method of claim 13, wherein a layered tile of the at least one layered tile comprises a shape including a first dimension of at least approximately 10 inches and a second dimension of at least approximately 10 inches.
